(19) United States
(12) Patent Application Publication
(10) Pub. No.: US 2011/0274537 A1
(43) Pub. Date: Nov. 10, 2011

(54) BLADE EXCITATION REDUCTION METHOD AND ARRANGEMENT

(76) Inventors: Loc Quang Duong, San Diego, CA (US); Xiaolan Hu, San Diego, CA (US)

(21) Appl. No.: 12/776,412

(22) Filed: May 9, 2010

(51) Int. Cl. F01D 25/24; B23P 15/02

(52) U.S. Cl. 415/182.1; 29/889.721

(57) ABSTRACT

An impeller shroud is configured to receive an impeller. The impeller shroud establishes a plurality of air-bleed holes configured to communicate air with an impeller. The air-bleed holes are circumferentially distributed about the impeller shroud. The circumferential spacing between some adjacent air-bleed holes within the plurality of air-bleed holes is different than the circumferential spacing between other adjacent air-bleed holes within the plurality of air-bleed holes. A diffuser vane is configured to direct pressurized air to the combustor, the diffuser vanes are circumferentially distributed about the blade exducer. The circumferential spacing between some adjacent diffuser vanes within the plurality of diffuser vanes is different than the circumferential spacing between other adjacent diffuser vanes within the plurality of diffuser vanes.

### BACKGROUND

This disclosure relates generally to reducing blade excitation. More particularly, this disclosure relates to reducing excitation due to air moving against the blades.

Turbomachines, such as gas turbine engines and auxiliary power units, are known and include multiple sections, such as a fan section, a compression section, a combustor section, and a turbine section. During stable operation, air moves into the turbomachines via the fan section of a fan engine or via the inlet housing of an auxiliary power unit. The air is compressed as the air moves through the compression section. The compressed air is then mixed with fuel and combusted in the combustor section. Products of the combustion are expanded in the turbine section to rotatably drive the machinery.

Turbomachines include multiple blades arranged in blade arrays. For example, the compression sections of some turbomachines include a radial compressor (or impeller) at least partially received within a shroud assembly. The compressor includes both main blades and splitter blades connected to a disk. The shroud assembly of the compression section extends from an inlet opening to an outlet opening. Air moves axially to the radial compressor through the inlet opening of the impeller shroud assembly. Air also communicates to the compressor through a series of air-bleed holes established in the impeller shroud assembly. The air, especially the air moving through the air-bleed holes, can introduce pressure disturbances that excite the blades of the compressor, particularly the splitter blades. Other structures of the turbomachine, such as diffuser structures, located downstream of the impeller, can introduce other pressure field disturbances that excite the impeller blades. Excessive excitation can fatigue, crack, and dislodge portions of the blades.

In the operating speed range of some turbomachines, the blades resonate due to interference with excitation caused by pressure field disturbance as air moves through the air-bleed holes or the diffuser vanes in the gas flow path. Removing or eliminating the resonance is difficult due in part to design constraints, such as geometric constraints of components, performance requirements (i.e. shock, boundary layer, choke and surge), space limitations and the not well separated Eigen-nature of blade frequencies.

### SUMMARY

An example impeller shroud is configured to receive an impeller. An inlet end of the impeller shroud at the inlet end establishes a plurality of air-bleed holes configured to communicate air toward the impeller. The air-bleed holes are circumferentially distributed about the impeller shroud. The circumferential spacing between some adjacent air-bleed holes within the plurality of air-bleed holes is different than the circumferential spacing between other adjacent air-bleed holes within the plurality of air-bleed holes.

An example vane assembly includes a base establishing an axis and vanes extending from the base. The vanes are circumferentially distributed about the axis. The circumferential spacing between some adjacent vanes is different that the circumferential spacing between other adjacent vanes. The vanes are configured to influence flow through an impeller of a turbomachine.

The anti-nodes of a blade moving into a natural frequency are typically higher magnitudes of vibration. There may be more than one anti-node on a given airfoil design. The primary anti-node typically has the highest magnitude of vibration.

An example method of reducing stress on an airfoil includes performing a modal analysis on an airfoil array and, among the natural frequencies found within the operating speed range, selecting a natural frequency of the airfoil array, having the primary anti-node furthest from the diffuser vane position leading edge (LE). The method selects a quantity of vanes corresponding to pressure field disturbance excitation order frequency closest to the above selected natural frequency of the airfoil array (having primary anti-node furthest from the LE diffuser vane).

An example method of reducing stress on an airfoil includes performing a modal analysis on an airfoil array and, among the natural frequencies found within the operating speed range, selecting a natural frequency of the airfoil array having the primary anti-node furthest from the air-bleed hole location. The method selects a quantity of air-bleed holes corresponding to pressure field disturbance excitation order frequency closest to the above selected natural frequency of the airfoil array (having a primary anti-node furthest from the air-bleed hole).

These and other features of the disclosed examples can be best understood from the following specification and drawings, the following of which is a brief description:

### BRIEF DESCRIPTION OF THE DRAWINGS

FIG. 1 shows an example auxiliary power unit (APU).

FIG. 2 shows a section view of a compression section of the FIG. 1 APU.

FIG. 3 shows a perspective view of an impeller shroud of the FIG. 1 APU.

FIG. 4A shows a perspective view of an impeller of the FIG. 1 APU.

FIG. 4B shows another perspective view of an impeller of the FIG. 1 APU having a primary anti-node at a splitter leading edge and aligned with the air-bleed holes.

FIG. 4C shows another perspective view of an impeller of the FIG. 1 APU having a splitter primary anti-node at chord mid-span away from the air bleed holes.

FIG. 5 shows a section view of an air injection pathway communicating air to a air-bleed hole of the FIG. 3 impeller shroud.

FIG. 6A shows a disturbance pressure profile of a prior art compression section with symmetric arrangement (bleed holes/diffuser vanes).

FIG. 6B shows a disturbance pressure profile of the FIG. 2 compression section with asymmetric arrangement (bleed holes/diffuser vanes).

FIG. 6C shows a close-up of view of a portion of the FIG. 6B disturbance pressure profile with air injection (bleed holes) or bleed hole (diffuser vanes).

FIG. 7 shows an example method for reducing blade excitation.

FIG. 8 shows a front view of an example diffuser vane assembly of the FIG. 1 engine.

FIG. 9 shows a side view of the FIG. 8 diffuser vane assembly.

FIG. 10 shows a close-up view of a portion of the FIG. 8 diffuser vane assembly.

### DETAILED DESCRIPTION

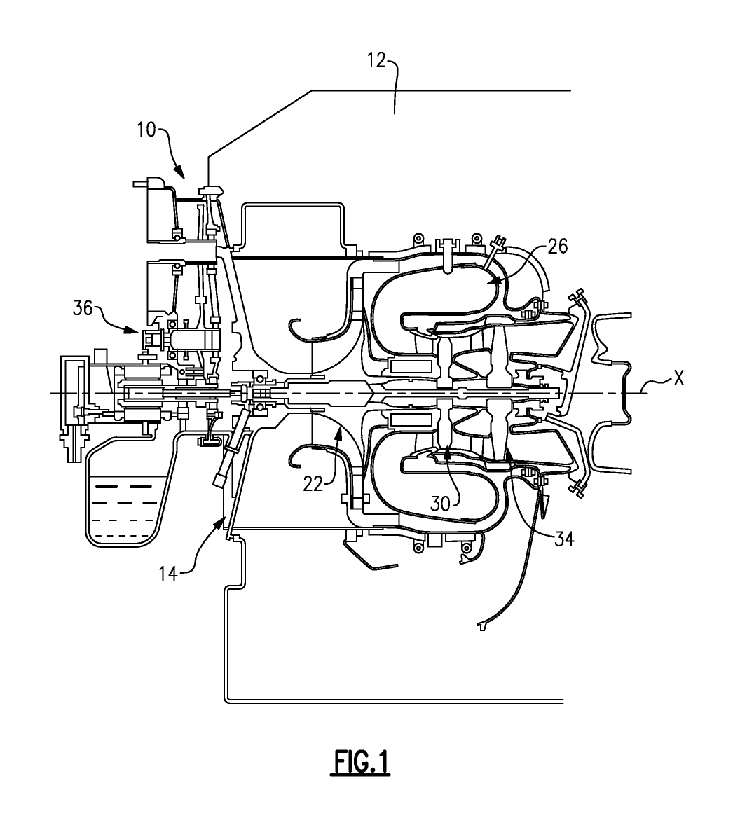

FIG. 1 schematically illustrates an example auxiliary power unit (APU) 10 for use in an aircraft 12. The APU 10 is a type of turbomachine. The APU 10 includes a compressor 22, a combustor 26, a high-pressure turbine 30, a low-pressure turbine 34, and a gearbox 36. The APU 10 is circumferentially disposed about an engine axis X.

During operation, fluid such as air is pulled into the APU 10 though the inlet housing 14, pressurized by the compressor 22, mixed with fuel, and burned in the combustor 26. The turbines 30 and 34 extract energy from the hot combustion gases flowing from the combustor 26 to drive the compressor 22 and the load gearbox 36. The examples described in this disclosure are not limited to the single spool engine architecture described, however. Other examples architectures of turbofan gas turbine engine include two-spools or three-spools.

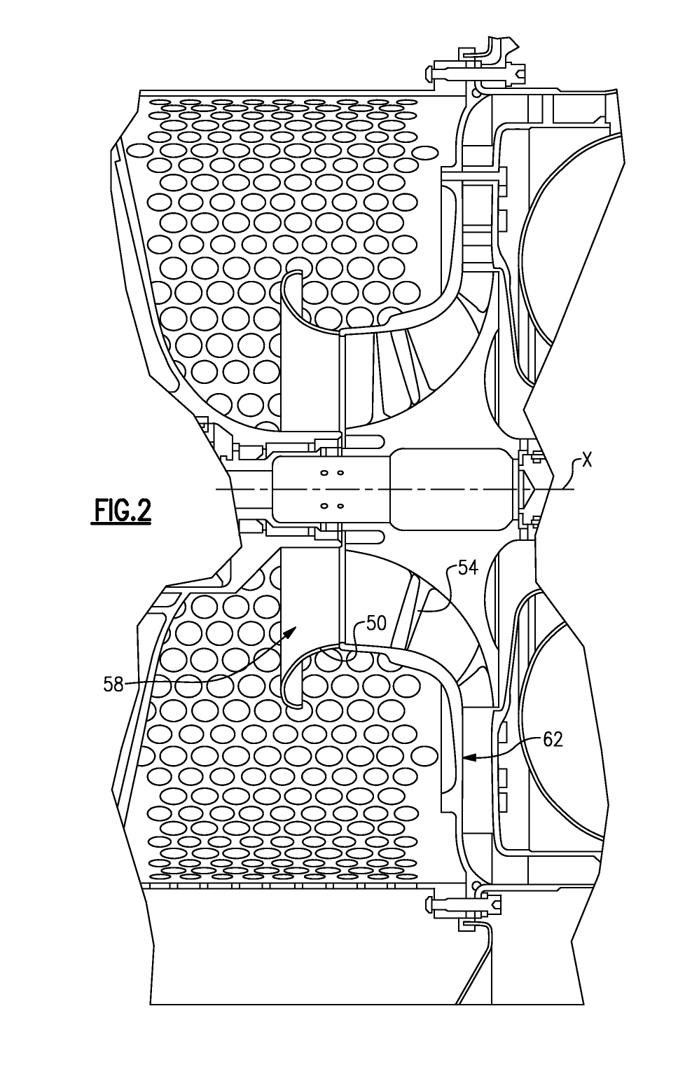

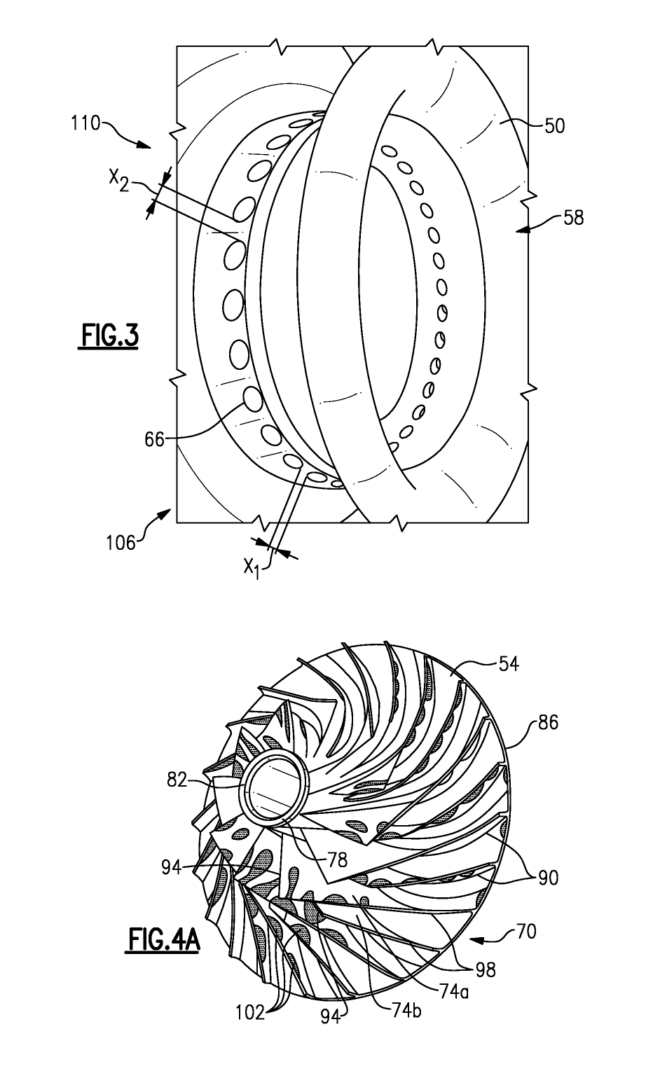

Referring to FIGS. 2-4 with continuing reference to FIG. 1, an example impeller shroud 50 is configured to receive a gas turbine impeller 54. The impeller 54 is coaxially aligned with the impeller shroud 50 when received within the impeller shroud 50.

The impeller shroud 50 includes a main inlet 58 and an outlet 62. The impeller shroud 50 includes several circumferentially distributed air-bleed holes 66. Fluid such as air moves through the main inlet 58 to the impeller 54. The impeller also interacts with the air flowing through the bleed holes 66.

The impeller 54 includes a blade array 70 (also referred to as an airfoil array) having multiple of blades 74a and 74b extending from a conical base portion 78. The base portion 78 extends from a hub 82 to a disk 86.

The blades 74a and 74b each have a trailing edge 90 attached to disc 86 and an unattached leading edge 94. A side edge 98 extends from the trailing edge 90 to the leading edge 94. The blades 74b have a shorter chord length than the other blades 74a. The blades 74b with the shorter chord lengths are splitter blades. In this example, the air-bleed holes 66 are axially aligned with the leading edges 94 of the blades 74b.

The example impeller shroud 50 communicates air to the rotating impeller 54 through the main inlet 58. Rotating the blades 74a and 74b compresses the air within the engine 10.

As can be appreciated, the impeller 54 represents a complex rotating structure. Within a typical operating frequency spectrum, the blades 74a and 74b each have natural frequencies associated with different disc nodal diameters (0, 1, 2, 3, etc.). The example blades 74a and 74b each include anti-nodes 102 associated with the natural frequencies.

Air communicated to the rotating impeller 54 through the plurality of air-bleed holes 66 induces a state of periodically unsteady pressure that imparts an aero-excitation frequency to the blades 74a and 74b The example frequency equals the rotor speed times the number of bleed holes 66.

In this example, the blades 74a and 74b experience an undesirable resonant vibration if the blade 74b has a natural frequency in the running speed range coincides with the pressure field disturbance excitation frequency and if its corresponding primary anti-node 104, located at the splitter LE tip, is axially aligned with the air-bleed holes 66. Typically, the blades 74b are influenced by the aero-excitation frequency from the bleed holes 66 more than the blades 74a.

Various components can affect the aero-excitation frequencies as the fluid (e.g., air) moves through the engine 10. For the example blade array 70, a resonance condition exists if the following relationship holds:

EO±ND=mB (1)

In Equation (1), EO is the order of the excitation source, ND is the number of the nodal diameter, m is an arbitrary integer number, and B represents number of blades 74a, 74b, or both.

In this example, a forward wave of the nth diameter mode is represented by a positive m in Equation (1). An excited backward wave is represented by a negative m in Equation (1). When there is no value of m that satisfies Equation (1), no vibration of the nth nodal diameter mode will be excited by the excitation source EO, even if the exciting frequencies coincide with the natural frequency of the disk 86.

The example impeller shroud 50 includes n air-bleed holes 66. The air-bleed holes 66 communicate air toward the blade array 70 to improve performance in relation to shock wave, boundary layer, choke, and surge.

In prior art, air-bleed holes are equally circumferentially spaced about the axis X of the engine 10. In the prior art, the air-bleed holes generate an unsteady pressure field exciting source of n engine order (nEO) on the blades 74a and 74b of the blade array 70.

In the example impeller shroud 50, the circumferential spacing between the air-bleed holes 66 is varied to reduce the effect of the unsteady pressure field exciting source.

To vary the circumferential spacing the impeller 54 is first represented as a matrix of discrete mass. The natural frequencies of the impeller 54 are then determined. The response of the blades 74a and 74b to aero-excitation is then established using a reduced modal model. In one example, X(t) is considered as a linear combination of a limited number of interested orthogonal mode shapes:

$$X = {\sum }_{k} {φ}_{k} {q}_{k} = [ Φ ] \qquad ( 2 )$$

In example Equation (2), the normal modes are represented as Φ, and the normal or modal coordinates are represented as q.

The Fourier transforms are then determined using below Equation (3) (which neglects the effects of damping and is expressed in normal coordinates):

[Φ]^{T}[M][Φ]{q″}+[Φ]^{T}[K][Φ]{q}=[Φ]^{T}{P(ω)} (3)

In Equation (3), {P(ω)} is the Fourier transform of {P(t)}. As can be appreciated, Equation (3) represents the response of the modes in each of the blades 74a and 74b to the excitation sources in each engine order. The modes can be evaluated independently utilizing Equation (3).

In Equation (3), [Φ]^{T} {P(ω)} represents the effect of the unsteady pressure field exciting source (which is expressed in terms of blade vibratory stresses). Changes to [Φ]^{T} {P(ω)} reveal how those changes manifest themselves as vibratory stresses on the blades 74a and 74b.

Again, in this example, the level of interaction between fluid and blades 74a and 74b is determined based on the amount of energy transferring from fluid to blade 74a and 74b. As shown in Equation (4) below, the aerodynamic work per cycle of blade motion is determined by taking the time integration of the dot product of the pressure and the blade velocity in one period of displacement over the blade area:

$$W = {\int }_{0}^{T} \{ ∯ [ - P \vec{n} \dot{X} d A ] \} d t \qquad ( 4 )$$

To reduce the blade dynamic stress at a particular blade natural frequency, the fluid energy transferring to blade 74a and 74b at that corresponding blade natural frequency is reduced, interrupted, or both in each revolution.

In one example, the flow field characteristics are reduced in each revolution of the blade array 70 by varying the circumferential spacing of the air-bleed holes 66. The total number of air-bleed holes 66 does not change in some examples. In other examples, the total number of air-bleed holes is increased or reduced.

For example, thirty-one air-bleed holes 66 can be divided into a first group 106 of fifteen air-bleed holes 66 on one half of the impeller shroud 50 and a second group 110 of sixteen air-bleed holes 66 on the other half of the impeller shroud 50. A distance X₁ between adjacent air-bleed holes 66 of the first group 106 is different that a distance X₂ between adjacent air-bleed holes 66 of the second group 110.

The fifteen air-bleed holes 66 of the first group 106 (on the basis of thirty air-bleed holes 66 equally spaced about the axis X) thus generate an excitation source of 30EO. Further, the sixteen air-bleed holes 66 of the second group 110 (on the basis of thirty-two air-bleed holes 66 equally spaced about the axis X) generates an excitation source of 32EO.

In general, given an odd number of n air-bleed holes 66, the asymmetric configuration of air-bleed holes 66 includes a first group consisting of (n−1)/2 air-bleed holes 66 and a second group consisting of (n+1)/2 air-bleed holes 66. These groups introduce a harmonic of (n−1), n, and (n+1) excitation orders.

In general, given an even number of n air-bleed holes 66, the asymmetric configuration of air-bleed holes 66 includes a first group consisting of (n/2)−1 air-bleed holes 66 and second group of (n/2)+1 air-bleed holes 66. These groups introduce a harmonic of (n/2)−1, n, and (n/2)+1 excitation orders.

When compared to prior art air-bleed holes that are symmetrically arranged about the axis X, these example asymmetric configurations possesses the following aerodynamic loading amplitude characteristics (where EO represents the excitation order):

nEO_{(asymmetric)}<nEO_{(symmetric)}

(n−1)EO_{(asymmetric)}<nEO_{(symmetric)}

n+1)EO_{(asymmetric)}<nEO_{(symmetric)}

Modifying the air-bleed holes 66 to have an asymmetric relationship influences [Φ]^{T}{P(ω)} in Equation (3).

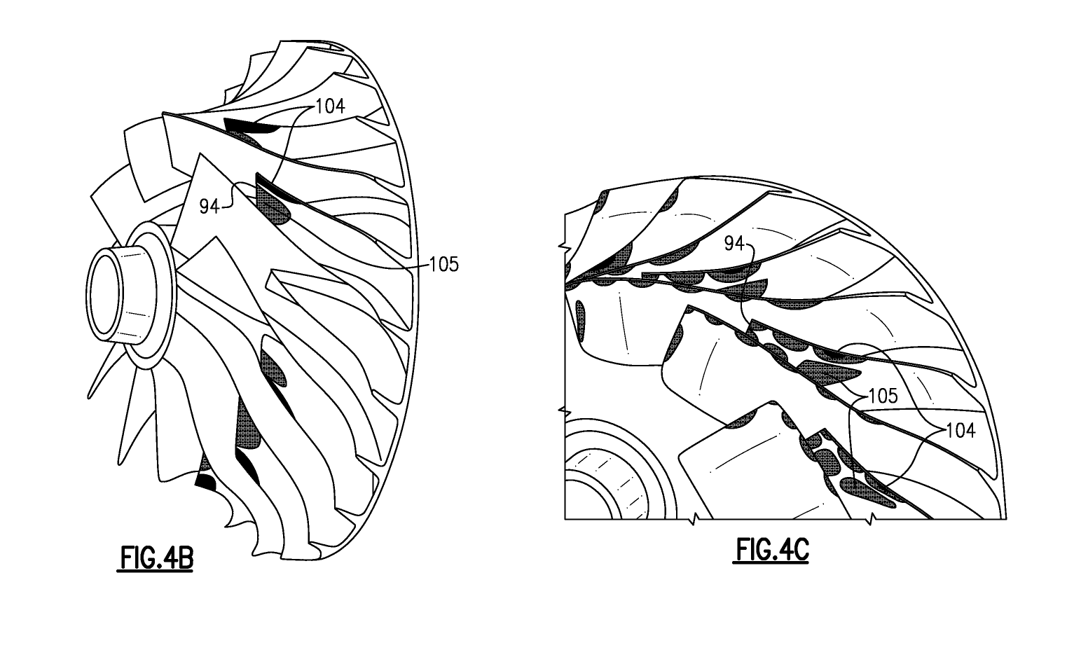

Referring to FIG. 5 with continuing reference to FIGS. 2-4, in another example, flow field characteristics are further influenced modifying the local pressure field by air injection through air injection passages 114 defined between an inner wall 118 and an outer wall 122 of the impeller shroud 50.

In this example, air is extracted from diffusers downstream of the impeller shroud 50 and injected or communicated to the air-bleed holes 66 through the air injection passages 114. The air injection passages 114 communicate air to the air-bleed holes 66 to lessen local turbulence. Specifically, the flow of air communicated through the air-bleed holes 66 produces local turbulence when the flow contacts other flows. The localized turbulence introduced by the air communicated through the air injection passages 114 breaks down the periodic pressure distribution in the tangential direction.

Further, the frequency of the air injected into the air-bleed holes 66 through the injection passages 114 is different than the frequency of the other air communicating through the air-bleed holes 66. The number of air-bleed holes 66 with air injection could be limited to a few asymmetrically distributed in the tangential direction. That is, each of the air-bleed holes 66 need not be associated with the air injection passageway 114.

In some examples, the impeller shroud 50 includes both asymmetrically distributed air-bleed holes 66 and air injection passages 114. In other examples, the asymmetrically distributed air-bleed holes 66 or the air injection passages 114 are used.

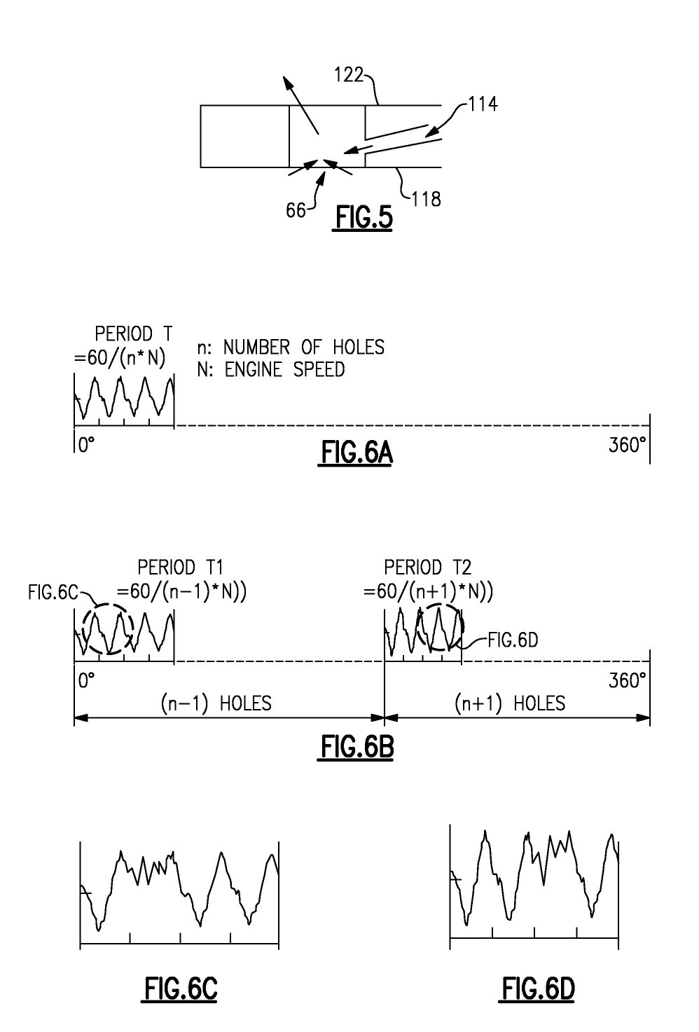

FIG. 6A graphically shows a disturbance pressure profile for a prior art impeller shroud having symmetrically distributed air-bleed holes. For relevant frequency ranges, the periodic non-sinusoidal forcing function for the prior art turbine having symmetrically distributed holes can be expressed in terms of the Fourier series of sine function as:

P(t)=P₀+ . . . +a₃₀ sin{30(EO)t+α₃₀}+ . . . (5)

In Equation (5), P₀ denotes average steady pressure, whereas a₃₀ and α₃₀ are the maximum amplitudes and phase angles corresponding to 30EO, respectively.

FIGS. 6B shows a disturbance pressure profile for the impeller shroud 50. Notably, the frequency of the profile changes every 180 degrees as the blade array 70 rotates. FIG. 6C shows a disturbance pressure profile for an impeller shroud 50 incorporating the air injection passages 114 of FIG. 5. Notably, the profile in FIG. 6C is less of frequent interval than the profile in FIG. 6B.

For relevant frequency ranges, the periodic non-sinusoidal forcing function for the turbine having asymmetrically distributed holes can be expressed in terms of the Fourier series of sine function as:

P(t)=P₀+ . . . +b₂₉ sin{29(EO)t+β₂₉}+b₃₀ sin{30(EO)t+β₃₀}+b₃₁ sin{31(EO)t+β₃₁}+ . . . (6)

The forcing function thus demonstrates that:

a₃₀>b₃₀; a₃₀>b₂₉; a₃₀>b₃₀ and a₃₀>b₃₁ (7)

As can be appreciated, the introduction of pressure pulsation would further reduce the amplitudes of the coefficients shown in Equation (7) in comparison to a₃₀ of Equation (5).

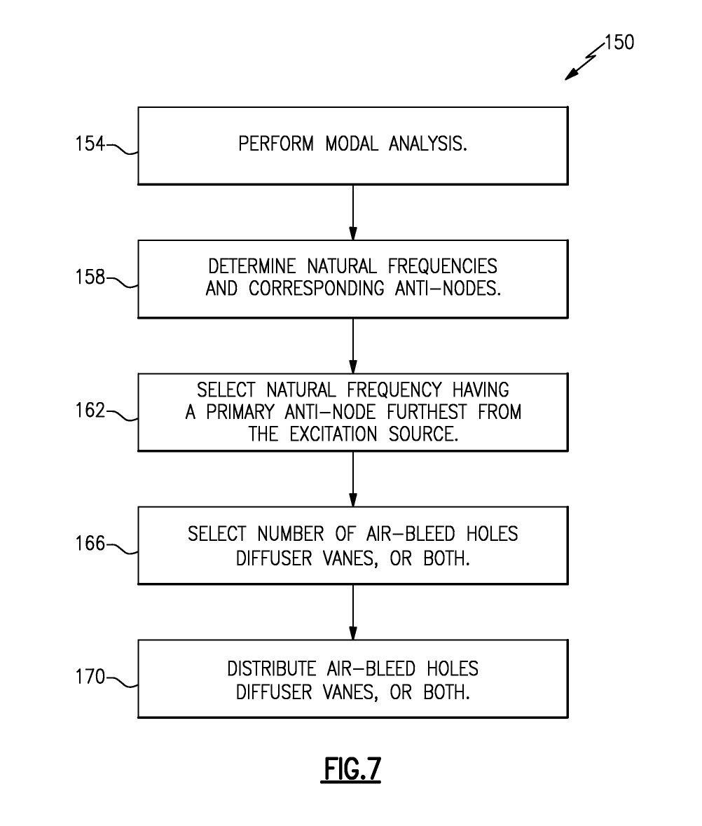

Referring to FIG. 7, an example method 150 for reducing blade excitation, and particularly the splitter blade excitation, includes a step 154 of performing a modal analysis on the impeller.

Next, the method 150 determines the blades' natural frequencies and corresponding mode shapes with associated anti-nodes at a step 158. The anti-nodes of a blade approaching a natural frequency are typically higher magnitudes of vibration. There may be more than one anti-node on a given airfoil design. The primary anti-node typically has the highest magnitude of vibration. The further the primary anti-node from the excitation source, the lesser the dynamic impact to the blade.

The method 150 then includes selecting the splitter natural frequency with blade primary anti-node furthest apart from the air-bleed holes location at a step 162. FIG. 4B shows an example of a splitter blade primary anti-node positioned at the splitter tip inducer and aligned with the air bleed holes. FIG. 4C shows an example of a splitter blade primary anti-node 104 located apart from the splitter blade inducer tip where the air bleed holes 66 are positioned. A secondary anti-node 105 is also shown.

At a step 166, the method 150 selects a number of air-bleed holes resulting in the excitation engine order frequency closest to the above chosen splitter natural frequency (having primary anti-node furthest apart from the air-bleed holes). The method 150 includes selecting a number of diffuser vanes in some examples.

At a step 170, the method 150 then determines an asymmetric distribution for the air-bleed holes that has harmonic engine orders resulting in the least aero-dynamic impact on the blade under consideration.

The example method may then incorporate air injection to some of the air-bleed holes to break down the periodic pressure distribution. Notably, the air injection pressure pulsation has a frequency different from the corresponding hole group passing frequency.

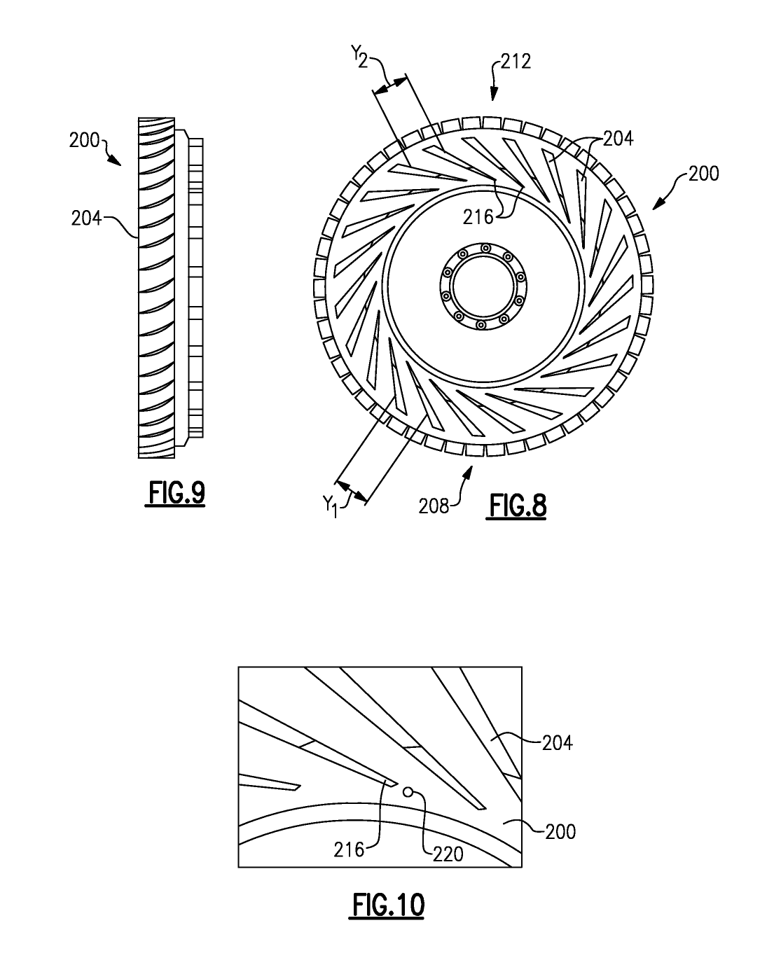

Referring to FIGS. 8-10 with continued reference to FIGS. 1-4, in other examples, fluid communicates through vanes 204 of a diffuser vane assembly 200 interacts with the example impeller 54. In such examples, the periodic and cyclic dynamic flow field characteristics are reduced in each revolution by simultaneously varying the circumferential spacing between groups of vanes 204 within the diffuser vane assembly 200 and by selecting the blade natural frequency having corresponding primary anti-node furthest apart from the diffuser vane leading edge.

For example, thirty-one diffuser vanes 204 can be divided into a first group 208 of fifteen diffuser vanes and a second group 212 of sixteen diffuser vanes. The first group 208 is positioned on a first half of the diffuser vane assembly 200, and the second group 212 is positioned on a second half of the diffuser vane assembly 200. The spacing Y₁ between adjacent vanes 204 of the first group 208 is different than the spacing Y₂ between adjacent vanes 204 of the second group 212.

The fifteen vanes of the first group 208 (on the basis of thirty vanes equally spaced about the axis) generate an excitation source of 30EO. The sixteen vanes of the second group 212 (on the basis of thirty-two vanes equally spaced about the axis X) generate an excitation source of 32EO.

In general, given an odd number of n vanes 204, the asymmetric configuration of vanes 204 includes a first group consisting of (n−1)/2 vanes 204 and a second group consisting of (n+1)/2 vanes 204. These groups introduce a harmonic of (n−1), n, and (n+1) excitation orders.

In general, given an even number of n vanes 204, the asymmetric configuration of vanes 204 includes a first group consisting of (n/2)−1 vanes 204 and second group of (n/2)+1 vanes 204. These groups introduce a harmonic of (n/2)−1, n, and (n/2)+1 excitation orders.

When compared to vanes 204 symmetrically arranged about the rotational axis X, the example asymmetric configurations possesses the following aerodynamic loading amplitude characteristics (where EO represents the excitation order):

nEO_{(asymmetric)<nEO}_{(symmetric)}

(n−1)EO_{(asymmetric)<nEO}_{(symmetric)}

(n+1)EO_{(asymmetric)<nEO}_{(symmetric)}

Modifying the vanes 204 to have an asymmetric relationship influences [Φ]^{T}{P(ω)} in Equation (3). Other components of the engine 10 could be similarly modified instead of, or in addition to, the vanes 204 of the diffuser vane assembly 200. For example, the inducer and bleed vanes present upstream of the impeller, or the diffuser vanes, located downstream of the impeller.

In another example, the flow field dynamic characteristics are reduced in each revolution by air bleed out near a leading edge 216 of the diffuser vanes 204. The pressurized air is bleed out through air-bleed holes 220. The localized turbulence from the air communicated through the air-bleed holes 220 breaks down the periodic pressure distribution in the tangential direction at the impeller blade trailing edge or exducer.

In some examples, the diffuser vane assembly 200 includes both asymmetrically distributed diffuser vanes 204 and diffuser air-bleed holes 220. In other examples, the asymmetrically distributed diffuser vanes 204 or diffuser air-bleed holes 220 are used.

Analogous to the air bleed holes, FIGS. 6A, 6B and 6C show the effect of pressure field disturbances at the diffuser leading edges. FIG. 6A graphically illustrates a disturbance pressure field profile for a prior art diffuser having a symmetrical vane arrangement. FIG. 6B shows a disturbance pressure profile for a diffuser leading edge having an asymmetric vane distribution. Notably, the frequency of the profile changes every 180 degrees as the blade array 70 rotates. FIG. 6C shows a disturbance pressure profile for an asymmetric diffuser vane arrangement incorporating the air bleed holes 220 of FIG. 10. Notably, intervals within the profile of FIG. 6C are less frequent than those in the profile of FIG. 6B.

Although example embodiments have been disclosed, a worker of ordinary skill in this art would recognize that certain modifications would come within the scope of the claims. For that reason, the following claims should be studied to determine their true scope and content.

We claim:

1. A method of reducing stress on an airfoil, comprising:
a) performing a modal analysis on an airfoil array;
b) selecting a natural frequency of the airfoil array having a primary anti-node within the airfoil array furthest from an air bleed hole location; and
c) selecting a quantity of air-bleed holes corresponding to an engine excitation order frequency closest to the selected natural frequency of the airfoil array.

2. The method of claim 1, including varying the circumferential distance between some of the air-bleed holes relative to others of the blades.

3. The method of claim 1, wherein selecting the natural frequency of the airfoil array comprises selecting a natural frequency of the airfoil array having the primary anti-node of splitter blades within the airfoil array furthest from the air bleed hole location.

4. The method of claim 1, wherein the air-bleed holes are distributed circumferentially about the airfoil array.

5. The method of claim 1, wherein the air-bleed holes are established within a diffuser structure downstream from the airfoil array.

6. The method of claim 1, wherein the airfoil array comprises an impeller.

7. The method of claim 6, wherein the air-bleed holes are established within an impeller shroud that receives at least a portion of the impeller.

8. The method of claim 7, wherein air injection passages are established between a radially inner surface and a radially outer surface of the impeller shroud.

9. The method of claim 1, wherein performing the modal analysis on the airfoil array comprises determining natural frequencies and corresponding anti-nodes within the operating speed range for a plurality of blades within the airfoil array.

10. A method of reducing stress on an airfoil, comprising:
a) performing a modal analysis on an airfoil array;
b) selecting a natural frequency of the airfoil array having a primary anti-node within the airfoil array furthest from the diffuser vane leading edge; and
c) selecting a quantity of vanes corresponding to an engine excitation order frequency closest to the above selected natural frequency of the airfoil array.

11. The method of claim 10, including varying the circumferential distance between some of the blades relative to others of the blades.

12. The method of claim 10, wherein the vanes comprise diffuser vanes located downstream from the airfoil array relative to flow through the engine.

13. The method of claim 10, wherein the vanes comprise inducer vanes located upstream the airfoil array relative to flow through the engine.

14. The method of claim 10, wherein the airfoil array comprises an impeller.

15. The method of claim 10, wherein performing the modal analysis on the airfoil array comprises determining natural frequencies and corresponding anti-nodes within the operating speed range for a plurality of blades within the airfoil array.

16. An impeller shroud, comprising:
an impeller shroud configured to receive an impeller, the impeller shroud establishing a plurality of air-bleed holes configured to communicate air toward the impeller, the air-bleed holes circumferentially distributed about the impeller shroud, wherein the circumferential spacing between some adjacent air-bleed holes within the plurality of air-bleed holes is different than the circumferential spacing between other adjacent air-bleed holes within the plurality of air-bleed holes.

17. The impeller shroud of claim 16, including a plurality of air injection passages established between a radially inner surface and a radially outer surface of the impeller shroud, each of the air injection passages configured to communicate air to one of the plurality of air-bleed holes.

18. A vane assembly, comprising:
a base establishing an axis; and
a plurality of vanes extending from the base, the vanes circumferentially distributed about the axis, wherein the circumferential spacing between some adjacent vanes within the plurality of vanes is different than the circumferential spacing between other adjacent vanes within the plurality of vanes, wherein the plurality of vanes are configured to influence flow through an impeller of a turbo machine.

19. The vane assembly of claim 18, wherein the base defines a plurality of air-bleed holes configured to communicate airflow near the leading edge of some of the vanes.
